(19) United States
(12) Patent Application Publication
(10) Pub. No.: US 2003/0021643 A1
(43) Pub. Date: Jan. 30, 2003

(54) Cabinet building method

(76) Inventor: Timothy B. Myers, Boise, ID (US)

Correspondence Address: STEPHEN M. NIPPER, DYKAS & SHAVER, LLP, PO BOX 877, BOISE, ID, 83701-0877, US

(21) Appl. No.: 09/917,448

(22) Filed: Jul. 27, 2001

(51) Int. Cl. B23B 35/00

(52) U.S. Cl. 408/1 R; 408/53

(57) ABSTRACT

An improved cabinet building method which converts the “frameless” or “32-mm System” to a 1.25 inch system. In such a 1.25 inch system, cabinet builders familiar with, or preferring, the Imperial system of measurement are able to more comfortably compute measurements required for cabinetry.

### BACKGROUND OF THE INVENTION

1. Field of the Invention

The present invention generally relates to methods of building cabinets, and more particularly relates to the positioning and drilling of holes in cabinet side panels for drawer guides, shelf clips, hinges, etc.

2. Background Information

One method of building cabinets is known as the “32-mm system” or the “System 32” or the “frameless cabinet system.” The concept of building cabinets using such a system originated in Europe. The “32-mm” measurement refers to the measurement, from center to center, of five millimeter holes drilled vertically on the inside of cabinet ends. These five millimeter holes serve a vital function in cabinet manufacturing, for instance, they are used for inserting pins to hold up shelving and are used for accurate placement of hinges and drawer slides.

A typical cabinet has a front, a back, a pair of ends, a bottom and a top. Thus, the term “ends” refers to the left and right sides of the cabinet. The inside surface of a particular end (which faces into the cabinet) is the surface into which these 5 mm holes are drilled. Commonly, two parallel, vertical rows of holes are drilled into each end inside surface. These two rows typically have at least a number of parallel holes between them, so that the holes in the first row are horizontal to the holes in the second row. In such a manner, a cabinet builder can quickly install a generally level drawer slide by attaching the front of the drawer slide to a hole in the first row, and then attaching the rear of the drawer slide to the analogous, horizontal hole in the second row. Likewise, level cabinet shelves can be installed, as is common in any typical cabinet or bookshelf.

Thus, many specialized items of hardware have been developed specifically taking into consideration the measurements in the 32-mm system. Of note is the use of hinges having preformed screw holes spaced 32 mm apart, so that the hinges can be quickly and easily installed into a cabinet by driving screws through the hinge's 32 mm spaced holes and into the 32 mm holes drilled into the cabinet ends.

A drawback to the “32-mm System” is that cabinet ends, drawers and door fronts need to be sized vertically in precise increments of 32 mm. This means that all of the components need to be cut to metric lengths. However, due to American consumer and American cabinetmaker preferences, a majority of American cabinet makers use the Imperial system (feet and inches), thereby constructing cabinets in inch measurements. While the dimensions of these cabinets are in inches, the 32-mm System is still used for the spacing of shelves, etc. This hybrid system is prone to error and inaccuracy. Because the 32-mm System dictates that the cabinet ends need to be sized vertically in precise increments of 32 mm, the cabinet builder is forced to convert a millimeter measurement into inches and fractions of inches. For instance, under the “32-mm System,” the height of a panel (end) may need to be 320 millimeters tall, which is approximately 12-19/32 inches. This conversion from millimeters to inches in fractions is never 100 percent accurate. Considering that the majority of American cabinet makers are manufacturing in inches and fractions of inches, this makes the vertical sizing of cabinet parts (cabinet heights) very awkward, often frustrating, less precise and prone to error.

Because the 32-mm System originated in Europe, all of the original manufacture of 32-mm System equipment was performed by European manufacturers. When this 32-mm System was adopted by American cabinetmakers, these cabinetmakers adopted the European system, including the use of the European manufactured equipment. While some equipment is manufactured in the United States today, this equipment is likewise modeled after the European 32-mm standard.

What is needed is a purely Imperial system which is compatible with hardware manufactured for the 32-mm system. The present invention solves this need.

### SUMMARY OF THE INVENTION

The present invention is an improved cabinet building method that utilizes preferably five millimeter holes drilled vertically on the inside of cabinet ends, wherein these five millimeter holes are spaced apart in precise increments of 1.25 inches on center. By spacing the holes 1.25 inches apart, American cabinet builders are able to more easily and quickly compute the necessary cuts (inches and fractions or decimals) necessary to build their cabinet components, while still being able to use 32-mm spaced hardware.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the description of the preferred embodiment are to be regarded as illustrative in nature, and not as restrictive.

### DESCRIPTION OF THE PREFERRED EMBODIMENTS

While the invention is susceptible of various modifications and alternative constructions, certain illustrated embodiments will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The present invention is a new method of building cabinets. The method is a derivative of the European “frameless” or 32-mm cabinet system. A typical frameless cabinet has a front, a back, a pair of ends, a bottom and a top. Thus, the term “ends” refers to the left and right sides of the cabinet. In building a frameless cabinet, the ends of the cabinet are, before assembly, predrilled with a number of holes for receiving hardware or attachment means installed later in the fabrication process. Examples of uses of said holes include: receiving dowels for attaching various components together, receiving screws attaching drawer slides, receiving screws attaching hinges, receiving shelf brackets, etc.

In the invented system, these holes are drilled in 1.25 inch increments in at least one vertical line in each of the cabinet ends. While the term “vertical” is used to represent the orientation of the line of holes when the cabinet is installed, these holes are typically drilled with the cabinet ends lying horizontal on a work surface. It is preferred that at least two, parallel lines be drilled in each cabinet end. The preferred holes are 5 mm in diameter, however other diameter holes are also envisioned, including, but not limited to holes of a ¼ inch diameter.

Utilizing such a system, the cabinet maker is able to utilize hardware, such as drawer slides and hinge plates, which are pre-formed based upon the “32-mm System.” Thirty-two millimeters (32 mm) is 1.2608 inches. Thus the real difference between 32 mm and 1.25 inches is 0.0108 inches. Because this difference is so minimal, screws inserted through cabinet hardware can be easily persuaded into the 1.25 inches spacing holes without any change in the strength or quality of the attachment. Thus the American cabinet maker can switch to a 1.25 inch system thereby simplifying the cutting and fabrication of components and cabinets (because all measurements will be in Imperial units), while utilizing the same industry standard hardware already manufactured.

For a cabinet maker, changing from the 32-mm System to the invented system will typically only entail switching the gearbox of the line boring machine used to drill the lines of hardware holes. The cabinet maker will merely need to replace his/her old gearbox having spindles with bits spaced 32 mm on center with a new gearbox having spindles with bits spaced 1.25 inches on center. Likewise, a single spindle on a CNC machine could be set up to accomplish this 1.25 inches on center spacing for holes drilled.

The drill bits used could be switched to an Imperial measurement too (from 5 mm to 3/16 inch, for instance). However such change is not wholly necessary because the impetus of the present invention is in eliminating the measuring of lengths in metric units, thereby making the diameter measurement of the hardware holes less of a critical element in the present invention.

While there is shown and described the present preferred embodiment of the invention, it is to be distinctly understood that this invention is not limited thereto but may be variously embodied to practice within the scope of the following claims.

I claim:

1. A line boring machine gearbox for use in pre-drilling cabinet ends, said gearbox comprising:
at least two drilling spindles for holding drilling bits, wherein said drilling spindles are spaced apart so that said drilling bits held therein are spaced 1.25 inches apart on center.

2. The line boring machine gearbox of claim 1, wherein said drilling bits have a diameter of 5 millimeters.

3. A method for building a frameless cabinet having a pair of opposing ends, said method comprising the step of:
pre-drilling at least one line of hardware holes able to receive cabinet hardware in each of said cabinet ends, wherein said hardware holes are spaced 1.25 inches apart on center.

4. The method of claim 3, wherein said hardware holes have a 5 millimeter diameter.

5. The method of claim 3, wherein said lines of hardware holes are generally vertical when said cabinet is assembled and installed.

6. The method of claim 3, wherein the number of lines of generally vertical hardware holes in each cabinet end is two.

7. In a method of building a frameless cabinet having a front, a back, a pair of ends, a bottom and a top, wherein said ends each have at least one line of hardware holes drilled therein, the improvement comprising spacing said hardware holes 1.25 inches on center.

8. The method of claim 7, wherein said hardware holes have a 5 millimeter diameter.

9. The method of claim 7, wherein said lines of hardware holes are generally vertical when said cabinet is assembled and installed.
